(19) United States
(12) Patent Application Publication
(10) Pub. No.: US 2021/0086538 A1
(43) Pub. Date: Mar. 25, 2021

(54) METHOD FOR CONTROLLING AN INKJET PRINTING MACHINE ON SLABS

(71) Applicant: KERAGLASS INDUSTRIES S.R.L., BAISO (RE) (IT)

(72) Inventor: Stefano SPEZZANI, BAISO (RE) (IT)

(21) Appl. No.: 17/022,782

(22) Filed: Sep. 16, 2020

(30) Foreign Application Priority Data
Sep. 24, 2019 (IT) 102019000017090

(51) Int. Cl. B41M 5/00; B41J 3/28; B41J 3/407

(52) U.S. Cl. CPC B41M 5/007; B41M 5/0047; B41J 3/407; B41J 3/28

(57) ABSTRACT

A method for controlling an inkjet printing machine on slabs, the printing machine including a support for a slab, and a printing device moveable above the support along a sliding direction and spaced apart from it. The method includes determining a layered decoration to be made with the printing device on the surface of the slab, the layered decoration being formed from the juxtaposition of a plurality of layers of monochromatic decoration, setting an activation sequence of a printing group of the printing device during the sliding of the printing device along the sliding direction as a function of the determined layered decoration, making the printing device slide along the sliding direction on the slab resting on the support, activating the printing group during the sliding of the printing device along the sliding direction based on the set activation sequence and on a predetermined mutual position of the printing group along the direction of mutually adjacent arrangement.

### TECHNICAL FIELD

The present invention concerns the field of inkjet printing, for example digital, on rigid slabs, particularly but not for limiting purposes transparent slabs, like slabs of glass, or slabs of any kind like slabs of ceramic, of natural stone, of metal or similar.

### PRIOR ART

As known, inkjet printing machines for printing on slabs have a conveyor on which sits a slab with a surface to be decorated facing upwards and a printing module equipped with one or more printing heads adapted for being arranged above the slab so as to release a plurality of drops of ink or decoration on the surface to be decorated of the slab itself.

In the field of inkjet printing on slabs, for example rigid slabs, printing machines fundamentally of two distinct types are known.

A first known type of printing machine provides for the slab to advance in steps on the conveyor along an advancing direction and at each step the printing module is made to slide (forwards and backwards) along a direction perpendicular to the advancing direction to release a strip of decoration that covers the entire width of the slab to be decorated on a limited axial segment of the surface to be decorated of the slab. The advancing in steps of the slab under the printing module that slides transversally with respect to the slab makes it possible to decorate the entire length of the slab in steps with consecutive strips of decoration.

A second known type of printing machine, also called single-pass, provides for the slab to advance at substantially constant speed on the conveyor along an advancing direction and for the printing module to be fixed on top of the conveyor, for example on a cross member that engages the entire span thereof, so as to remain stationary.

A drawback encountered in both types of printing machine illustrated above is the fact that the decoration printed through them is not particularly precise. Such a drawback is clearer when transparent slabs, like slabs of glass, are decorated, the transparency of which makes the printing defects even clearer, which can be essentially due to the micro movements and/or sliding of the slab on the conveyor during the advancing of the same slab, for example between one advancing step of the slab and the next one (in the first type of printing machine) or continuously (in the second type of printing machine).

Moreover, a further drawback encountered in so-called single-pass printing machines is the fact that it is practically impossible to carry out two “passes” of ink that can be juxtaposed and, therefore, the printing quality is affected.

Moreover, another drawback encountered in such types of printing machines is that it is impossible to make layered decorations, i.e. defined by a plurality of layers (monochromatic) juxtaposed on the surface of the slab, with a single printing module, but—in the case in which it is necessary to obtain this layered decoration—it is necessary to arrange many printing machines or many printing modules along the advancing line of the slab, but also in this case the possibility of changing decorations or sequences of juxtaposition of the layers seems particularly impracticable and requires long machine down times for the replacement or changing of the mutual order of the printing modules along the advancing direction of the slabs.

A purpose of the present invention is to overcome the aforementioned drawbacks of the prior art, in a simple, rational and low-cost solution.

In particular, a purpose of the present invention is to provide s method for controlling an inkjet printing machine that makes it possible to make a particularly defined and precise decoration, without defects that are perceptible to the naked eye even when the slab is a transparent slab.

Furthermore, a purpose of the present invention is to provide a method for controlling an inkjet printing machine that makes it possible to make defined layered decorations and can, if necessary, change, on the same slab or on the sequence of slabs to be processed, the sequence of juxtaposition of the layers and the decorations, in a fast and automated manner, without requiring maintenance interventions or mechanical change on the machine itself.

Such purposes are accomplished by the characteristics of the invention given in the independent claim. The dependent claims outline preferred and/or particularly advantageous aspects of the invention.

### SUMMARY OF THE INVENTION

For the purposes outlined above, the invention, particularly, provides a method for controlling an inkjet printing machine (10) on slabs (L), wherein the printing machine (10) comprising:
a support (20) for supporting a slab (L); and
a printing device (30) moveable above the support (20) along a sliding direction (D) and spaced apart from it, wherein the printing device (30) is provided with a plurality of printing groups (31) arranged adjacent with respect to a direction of mutually adjacent arrangement (G) parallel to the sliding direction (D) and each printing group (31) is equipped with at least one inkjet printing head (310), wherein each printing group (31) is configured to release a respective monochromatic decoration on a surface (L1) of the slab (L) resting on the support (20), and

wherein the method comprises:
determining a layered decoration to be made with the printing device (30) on the surface (L1) of the slab (L), wherein the layered decoration is formed from the juxtaposition of a plurality of layers of monochromatic decoration;
setting an activation sequence of one or more printing groups (31) during the sliding of the printing device (30) along the sliding direction (D) as a function of the determined layered decoration;
making the printing device (30) slide along the sliding direction on the slab (L) resting on the support (20);
activating one or more printing groups during the sliding of the printing device (30) along the sliding direction (D) based on the set activation sequence and on a predetermined mutual position of the printing groups (31) along the direction of mutually adjacent arrangement.

According to an aspect of the invention, the printing machine (10) can be configured to decorate the surface (L1) of a plurality of slabs (L) in sequence, the method further comprising:
changing the determining of the layered decoration and the setting of the activation sequence between two successive slabs (L) of the sequence of slabs (L).

Alternatively or additionally, the printing device (30) can be moveable above the support (20) along the sliding direction (D) in both sliding directions, i.e. in a forward sliding direction and a backwards sliding direction, the method further comprising:
depositing, through the printing groups (31), the complete layered decoration on the same surface (L1) of the same slab (L) with a plurality of outward and/or return strokes, respectively in the forwards sliding direction and/or in the opposite backwards sliding direction.

Furthermore, the printing machine (10) can comprise a locking and centring group (40) configured to contact the slab (L) temporarily locking and centring it on the support (20), the method comprising:
actuating the locking and centring group (40) during the movement of the printing device (30) along the sliding direction (D).

According to a further aspect, the support (20) can comprise a horizontal support plane (A) that comprises an advancing group to advance the slab (L) supported along a predetermined horizontal advancing direction (B), the method comprising:
making the printing device (30) slide along the sliding direction on the slab (L) resting on the support (20), wherein the sliding direction (D) of the printing device (30) is horizontal and parallel or perpendicular to the advancing direction (B).

Furthermore, the invention provides an inkjet printing machine (10) on slabs (L), wherein the printing machine (10) comprising:
a support (20) for supporting a slab (L); and
a printing device (30) moveable above the support (20) along a sliding direction (D) and spaced apart from it, wherein the printing device (30) is provided with a plurality of printing groups (31) arranged adjacent with respect to a direction of mutually adjacent arrangement (G) parallel to the sliding direction (D) and each printing group is equipped with at least one inkjet printing head (310), wherein each printing group (31) is configured to release a respective monochromatic decoration on a surface (L1) of the slab (L) resting on the support (20).

Advantageously, the printing machine (10) can also comprise an electronic control unit (U) configured to actuate the method as described above.

Furthermore, the printing machine (10) can further comprise:
a locking and centring group (40) configured to contact the slab (L) temporarily locking and centring it on the support (20).

### BRIEF DESCRIPTION OF THE DRAWINGS

Further characteristics and advantages of the invention will become clear from reading the following description provided as a non-limiting example, with the help of the figures illustrated in the attached tables.

FIG. 1 is an axonometric view of a plant for the decoration of slabs equipped with a printing machine according to the invention.

FIG. 2 is an axonometric view of a first embodiment of a printing machine according to the invention, in which the protective casing has been removed for better understanding of the figure.

FIG. 3 is an axonometric view of a second embodiment of a printing machine according to the invention, in which the protective casing has been removed for better understanding of the figure.

FIG. 4 is an axonometric view of a roller conveyor (equipped with a centring and locking group) of the printing machine according to the invention, both according to the first and the second embodiment.

FIG. 5 is a first axonometric view of a centring and locking group of the printing machine according to the invention, both according to the first and the second embodiment.

FIG. 6 is a second axonometric view of a centring and locking group of the printing machine according to the invention, both according to the first and the second embodiment.

FIG. 7 is a side view of FIG. 2.

FIG. 8 is a plan view of FIG. 2 in a first operative step of the printing machine.

FIG. 9 is a plan view of FIG. 2 in a second operative step of the printing machine.

FIG. 10 is a plan view of FIG. 2 in a third operative step of the printing machine.

FIG. 11 is a side view of FIG. 3.

FIG. 12 is a plan view of FIG. 3 in a first operative step of the printing machine.

FIG. 13 is a plan view of FIG. 3 in a second operative step of the printing machine.

FIG. 14 is a plan view of FIG. 3 in a third operative step of the printing machine.

FIG. 15 is a schematic view of the decoration process able to be carried out with the printing machine according to the invention.

FIG. 16 is a scheme of the control method of the printing machine according to the invention.

### BEST EMBODIMENT OF THE INVENTION

With particular reference to such figures, a plant is described for the decoration of rigid slabs, particularly but not for limiting purposes optically transparent slabs, like slabs of glass or similar, globally indicated with the letter L.

The term slabs L is meant to indicate any sheet-like body of any material, like for example preferably glass and ceramic, but also metal, natural stone or another material suitable for making up the slab.

Moreover, the slab L can be of any shape or size, for example it can be flat or concave, polygonal or rounded or a combination thereof.

The plant comprises an inkjet printing machine 10, preferably a digital inkjet printing machine, which is configured to release a decoration on a surface L1 of one or more slabs L.

Preferably, the decoration can be a layered decoration, i.e. formed from the juxtaposition of a plurality of layers of monochromatic decoration, wherein the layers of monochromatic decoration can be of different or the same colours or compositions.

The printing machine 10 comprises a support 20 for supporting at least one slab L resting on its own lower resting surface opposite to the upper surface L1 to be decorated.

The support 20 comprises a horizontal support plane A on which the slabs L are intended to rest with their surface L1 to be decorated facing upwards.

The support 20 comprises, preferably, an advancing group to advance the slab L supported on the support plane along a predetermined horizontal advancing direction B (substantially rectilinear).

In the preferred example illustrated, the advancing group comprises a roller conveyor, in particular, the advancing group comprises a roller conveyor 21, which generally provides for a plurality of revolving rollers 210 arranged parallel to one another and coplanar to one another to define the aforementioned horizontal support plane A on which the slabs L to be decorated rest.

In practice, each roller 210 of the roller conveyor 21 rotates around its own horizontal rotation axis and perpendicular to the advancing direction B.

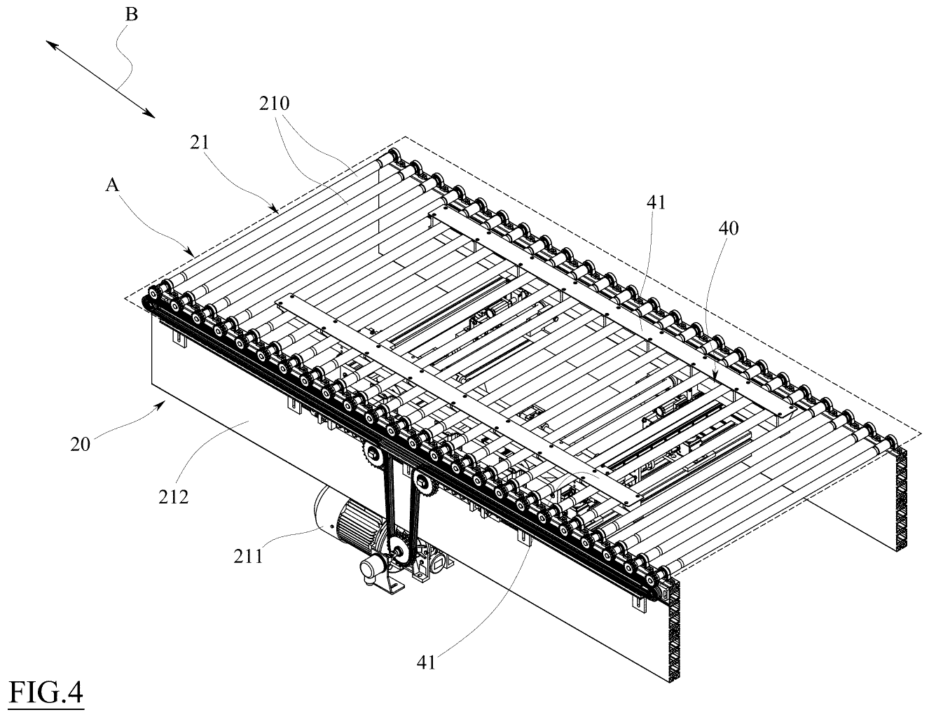

The rollers 210 of the roller conveyor 21 are connected to a motor 211 (see FIG. 4), in particular through relay members like chains or belts, said motor being adapted to make them rotate on themselves in a synchronous manner so as to advance the slabs L in the aforementioned horizontal advancing direction B (in one or both directions of travel).

The rotation speed of the rollers 210 regulates the advancing speed of the slabs L along the advancing direction B, which can be set and adjusted according to the processing requirements.

The roller conveyor 21 is equipped with a frame 212 for resting on the ground, in particular, the roller conveyor 21 is equipped with two side flanks that rest on the ground at their lower end and that rotatably support, at its top, the opposite distal ends of the rollers 210.

The actuation motor 211 of the rollers 210 can be arranged below the rollers themselves between the two side flanks or in another suitable position.

The rollers 210 of the roller conveyor 21 are preferably ceramic rollers, i.e. rollers made (exclusively) from ceramic material, without any rubber coating.

Preferably, the rollers 210 of the roller conveyor 21 have an outer shell, for example substantially impermeable (for example glazed) or almost impermeable, which is rigid (i.e. not deformable by the loads to which it is normally subjected in operation), preferably made of ceramic material (preferably, but not for limiting purposes refractory).

The roller conveyor 21 can have a main dimension parallel to the advancing direction B set by the rollers 210.

The advancing group, alternatively, could be defined by a conveyor belt or other conveyor of a type known in the field of printing machines.
The printing machine 10 comprises a printing device 30 configured to release a predetermined decoration on the (upper) surface L1 of the slab L.

The printing device 30 is preferably a digital (inkjet) printing device, as will be described better hereinafter.

The term decoration is meant to generally indicate the application of decorative fluids, like dyeing and/or decorating inks, but also the application of any product in fluid, liquid or semi-solid form, for example functional coatings, coatings, protective layers or anti-reflectants or similar.

The printing device 30 comprises at least one printing group 31 (or colour bar) configured to release a respective monochromatic decoration on an (upper) surface L1 of the slab L resting on the support 20.

Every printing group 31, preferably, is configured to dispense a respective colour. For example, each printing group 31 is intended to dispense a respective colour (different or, at the limit the same, with respect to each of the other printing groups 31).

Preferably, the printing device 30 comprises a plurality of printing groups 31 (for example 2, 3, 4 or 5 in number) arranged adjacent with respect to a direction of mutually adjacent arrangement G, preferably horizontal and perpendicular to the longitudinal axis of the printing groups themselves.

Each printing group 31 comprises at least one inkjet printing head 310, which is equipped with suitable ejector nozzles (not illustrated) of a decorative fluid, like for example an ink, a glaze or similar, to be dispensed on the surface L1 of the slabs L resting on the support plane A provided by the roller conveyor 21.

Each printing group 31 comprises a plurality of printing heads 310, for example arranged adjacent to one another along a direction of adjacent arrangement C (perpendicular with respect to the direction of mutually adjacent arrangement G of the printing groups 31).

In the illustrated example, each printing group 31 comprises one or a plurality of adjacent parallel rows (for example 2 in number) of printing heads 310, each of which consisting of a plurality of printing heads 310 arranged adjacent along a direction of adjacent arrangement C, wherein the printing heads 310 of two adjacent rows are offset from one another.

Each printing head 310 is defined by a block the lower face of which is engaged by the aforementioned ejector nozzles, which thus face downwards so as to be able to dispense drops of ink or other decorative fluid on the underlying surface L1 of the slab L, when suitably actuated through suitable injectors.

The printing heads 310 of each printing group 31 can be of any known type without limitations.

Globally, the printing group 31 has a main dimension (parallel to the direction of adjacent arrangement C of the printing heads 310 where there are more than one), which is at least equal to or greater than one of the sides (longer or shorter) of the slab L to be decorated.

For example, the main dimension of the printing group 31 is substantially equal to (or slightly less than) the length of the rollers 210 of the roller conveyor 21.

The printing device 30 also comprises a (per se known) feeding group of the decorative fluid to each printing group 31 (i.e. to each printing head 310 thereof), which communicates with one or more respective tanks in which the decorative fluid itself is contained.

Each feeding group comprises an electronic board, which manages the operation of each printing group 31 and/or each printing head 310 thereof and, therefore, the single ejector nozzles (through the respective injectors).

The decorative fluid dispensed by each printing group 31 can be monochromatic, or decorative fluid dispensed by each printing head 310 belonging to one of the printing groups 31 is monochromatic, or each printing head 310 of the same printing group 310 dispenses a decorative fluid of the same colour.

The printing device 30 comprises a support trolley 35, which is suspended on the support plane A of the support 20, a non-zero distance from it, and is moveable parallel to the support plane A with respect to the support 20 itself.

The support trolley 35 comprises a substantially box-like body.

For example, the support trolley 35 comprises a horizontal lower wall 350, which is parallel to the support plane A of the support 20 and is arranged a predetermined distance from it (for example height-adjustable through suitable adjustment members, preferably suitably motorised).

The support trolley 35, preferably the lower wall 350, comprises one or more housing seats (for example through openings) in which a respective printing head 310 (with its own ejector nozzles facing towards the support plane A and kept a predetermined distance from it) is received.

The support trolley 35 also comprises a pair of opposite flanks 351 rising from the opposite side to the lower wall 350, which are parallel to one another and spaced apart along the direction of adjacent arrangement C so as to contain inside them the entire main dimension of each printing group 31 (defined by the respective set of printing heads 310), singularly or the entire plurality thereof.

The flanks 351 can be joined by one or more protective walls for example undercut with them to define a containment volume of the support trolley 35 in which at least part of the feeding group and/or of the supply tanks of the decorative fluid to the printing heads 310 can be contained.

The support trolley 35, which actually defines the container of each printing group 31, is slidably supported on the support plane A.

In particular, the support trolley 35 is supported by the frame 212 of the roller conveyor 21, with possibility of sliding along a horizontal sliding direction D, i.e. parallel to (and spaced apart from) the support plane A.

The sliding direction D is perpendicular to the direction of adjacent arrangement C of the printing heads 310 supported by the support trolley 35.

Preferably, a supporting structure 36 of the support trolley 35 is rigidly connected, i.e. firmly fixed, to the frame 212 of the roller conveyor 21 above the support plane A.

The supporting structure 36 comprises a pair of supporting walls 361 and 362 separated from one another by a distance equal to or greater than the main dimension of the support trolley 35 (i.e. of the lower wall 350 thereof).

The supporting walls 361 and 362 are rigidly fixed to longitudinal guides 363, for example defined by grooved longitudinal members, with horizontal longitudinal axis to which suitable slides 352 are connected fixed to the opposite flanks 351 of the support trolley 35.

In particular, the supporting structure 36 comprises a vertical supporting wall 361 and a horizontal supporting wall 362, which are singularly supported by the frame 212 of the roller conveyor 21.

Correspondingly, a slide 352 of the support trolley 35, which is coupled with the longitudinal guide 363 of the vertical supporting wall 361 is fixed laterally to the outside of one of the flanks 351 of the support trolley 35, and another slide 352 of the support trolley 35, which is coupled with the longitudinal guide 363 of the horizontal supporting wall 362 is, on the other hand, fixed below the opposite flank 351 of the support trolley 35, for example below a bracket facing towards the outside of the respective flank 351.

The support trolley 35 is actuated to slide along the sliding direction D, in the two sliding directions, by a linear actuator group.

Preferably, but not for limiting purposes, the actuator group comprises (or consists of) a linear motor 37, which is supported by one of the supporting walls of the supporting structure 36, preferably by the vertical supporting wall 361.

The printing device 30 also comprises at least one heating device 38 arranged close to the support 20, distanced from it, and configured to heat the surface L1 of the slab L resting on the support plane A of the support 20.

The heating device 38 is, preferably, moveable on the support plane A of the support 20 and a predetermined non-zero distance from it as a unit with the printing group 31 or the plurality of printing groups 31.

In practice, the heating device 38 is slidably associated with the support 20 so as to be able to slide along the aforementioned sliding direction D together with the printing head 310.

In the preferred embodiment, the heating device 38 is supported by the support trolley 35, for example close to the lower wall 350 thereof.

The heating device 38 is, for example, an elongated body with horizontal longitudinal axis, parallel to the direction of adjacent arrangement C of the printing heads 310.

For example, the heating device 38 has a length at least equal to or greater than one of the sides (longer or shorter) of the slab L to be decorated, preferably substantially equal to (or slightly less than) the length of the rollers 210 of the roller conveyor 21.

The heating device 38, in practice, is arranged with its longitudinal axis perpendicular (and horizontal) to the direction of mutually adjacent arrangement G of the printing groups 31, i.e. parallel to the direction of adjacent arrangement C of the printing heads 310 (i.e. the main direction of each printing group 31) and spaced from it (for example coplanar with respect to a horizontal plane), actually being aligned with the printing groups 31 along an alignment direction parallel to a sliding direction D.

The heating device 38 can be arranged upstream and/or downstream of each printing group 31 or of the plurality of printing groups 31 in any sliding direction of the printing groups 31 (and of the support trolley 35) in the sliding direction D. In a preferred embodiment, the printing device 30 comprises a pair of heating devices 38, one of which is arranged upstream and the other downstream of each printing group 31 or of the plurality of printing groups 31 in the sliding direction thereof (and of the support trolley 35) in the sliding direction D.

The heating device 38 that is arranged upstream of the printing group 31 or of the plurality of printing groups 31 acts as preheating element, adapted for preheating the surface L1 of the slab L before the printing group releases the decorative fluid on it; the heating device 38 that is arranged downstream of the printing group 31 or of the plurality of printing groups 31 acts as a drying element of the decorative fluid deposited by the printing group 31 or by the plurality of printing groups 31.

Each heating device 38 comprises (or consists of) at least one infrared lamp or many infrared lamps.

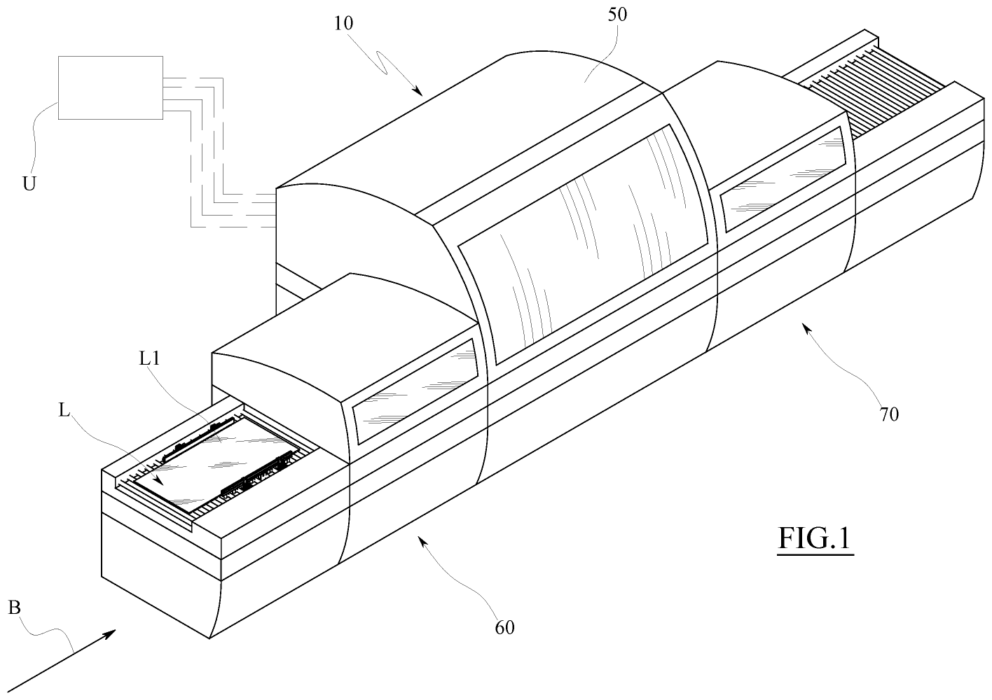

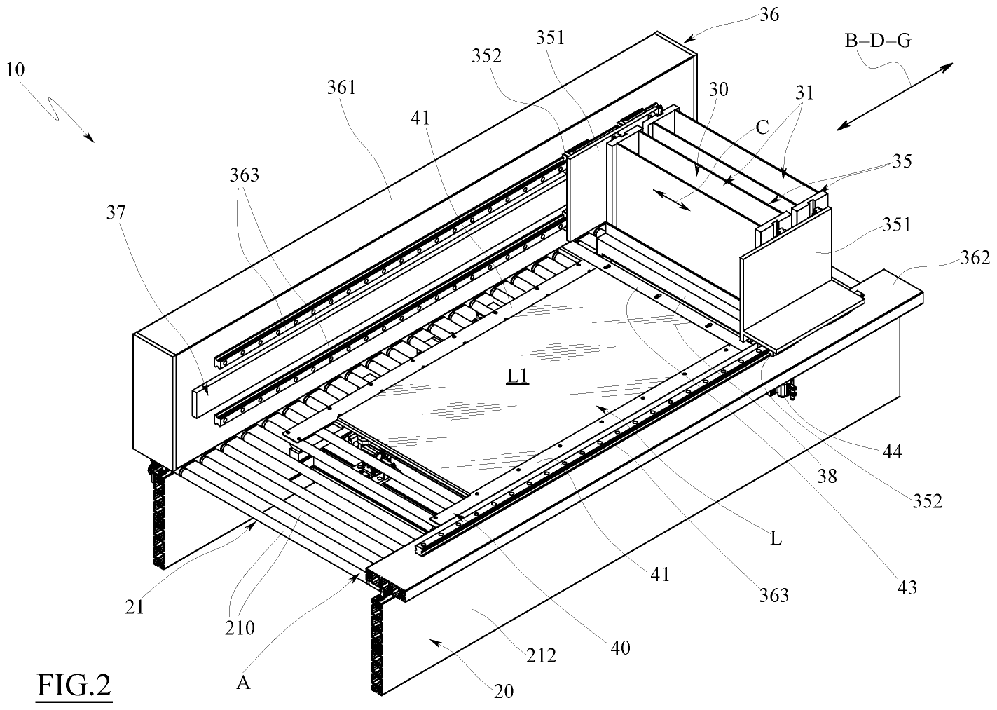

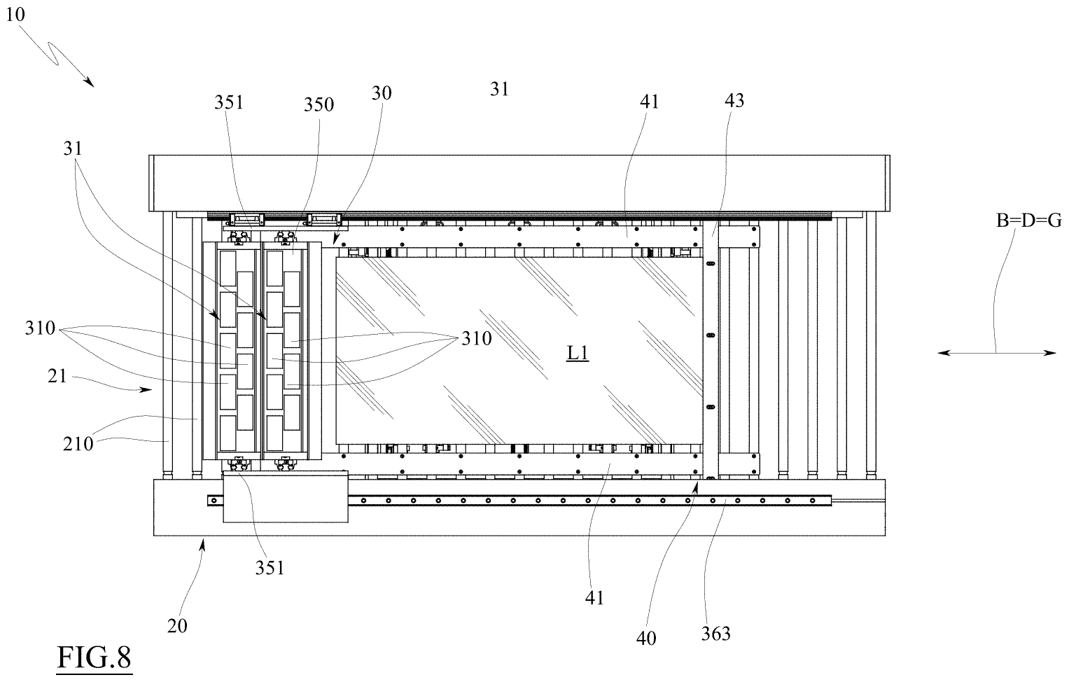

In a first embodiment shown in FIGS. 1, 2, 4-10, the sliding direction D of the support trolley 35, i.e. of each printing group 31 (and of each heating device 38) with respect to the support 20, is parallel to the advancing direction B imposed on the slabs L by the support itself, i.e. by the rollers 210 of the roller conveyor 21. In this case, the supporting walls 361 and 362 and, therefore the longitudinal guides 363 supported by them, extend parallel to the advancing direction B and, preferably each of them is supported above a respective side flank for resting on the ground that defines the frame 212 of the roller conveyor 21.

For example, the distance between the supporting walls 361 and 362 and, therefore the longitudinal guides 363 supported by them, is substantially equal to the length of the rollers 210 of the roller conveyor 21.

The support trolley 35 is, therefore, supported above the support plane A defined by the rollers 210 of the roller conveyor 21, so that the direction of mutually adjacent arrangement G of the printing groups 31 is parallel to the advancing direction B (and, therefore, the direction of adjacent arrangement C of the printing heads 310 or the main direction of each printing group 31) is perpendicular to the advancing direction B).

The length of the longitudinal guides 363 (and/or of the supporting walls 361 and 362) is substantially equal to (or slightly less than) the length of the support plane A along the advancing direction B.

In practice, the support trolley 35 can slide along the sliding direction D for a (maximum) sliding stroke substantially equal to the length of the support plane A (defined by the rollers 210 of the roller conveyor 21) along the advancing direction B (which is greater than or equal to a maximum main dimension of the slab L that can be decorated with the printing machine 10).

In this case, the main direction of each printing group 31 is such as not to be less than the side of the slab L perpendicular to the advancing direction B thereof that can be decorated with the printing machine 10.

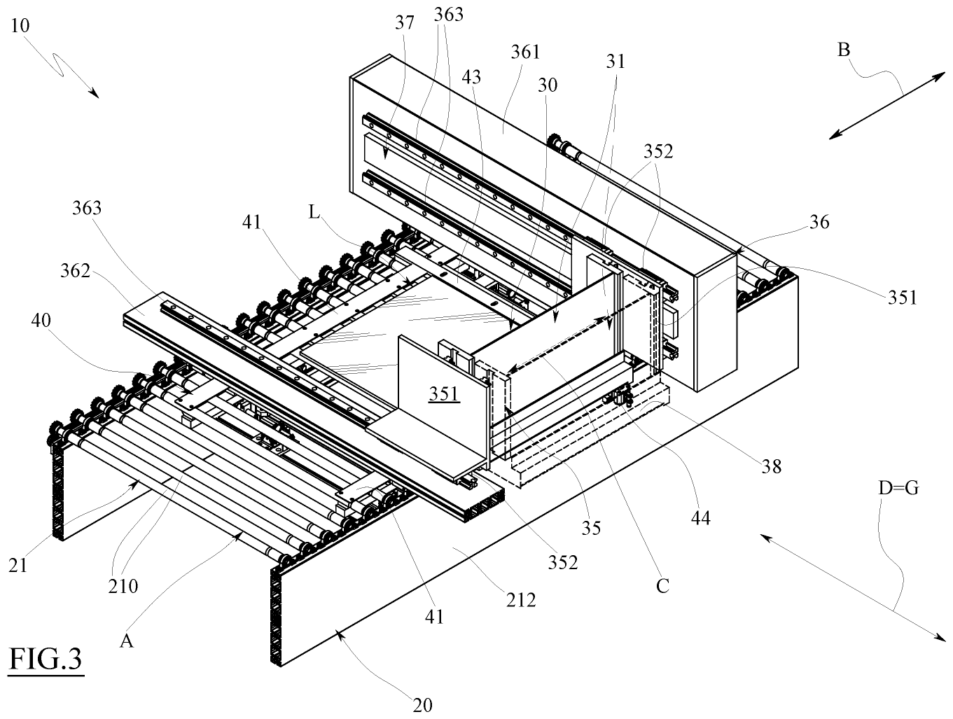

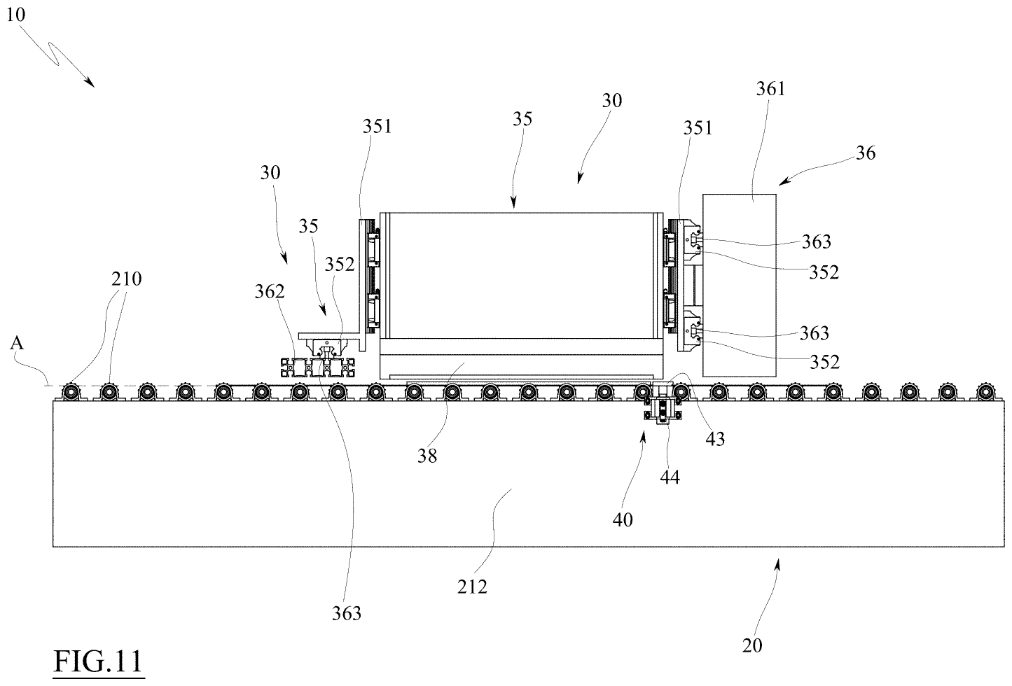

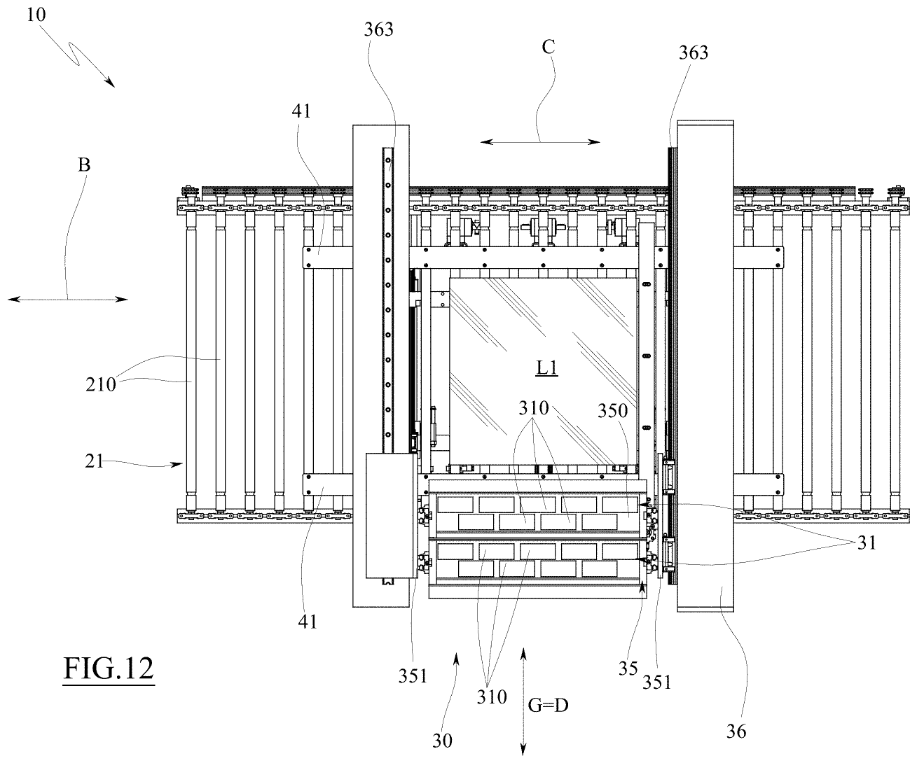

In a second embodiment shown in FIGS. 1, 3, 4-6, 11-14, the sliding direction D of the support trolley 35, i.e. of each printing group 31 (and of each heating device 38) with respect to the support 20, is perpendicular to the advancing direction B imposed on the slabs L by the support itself, i.e. by the rollers 210 of the roller conveyor 21.

In this case, the supporting walls 361 and 362 and, therefore, the longitudinal guides 363 supported by them, extend longitudinally perpendicular to the advancing direction B and, preferably, each of them is supported on top by both of the side flanks for resting on the ground that defines the frame 212 of the roller conveyor 21, for example in a central area of the longitude of the support plane A (i.e. of the roller conveyor 21).

For example, the distance between the supporting walls 361 and 362 and, therefore the longitudinal guides 363 supported by them, is substantially equal to (or less or greater than) the length of the rollers 210 of the roller conveyor 21.

The support trolley 35 is thus supported above the support plane A defined by the rollers 210 of the roller conveyor 21, so that the direction of mutually adjacent arrangement G between the printing groups 31 is perpendicular to the advancing direction B, i.e. the direction of adjacent arrangement C of the printing heads 310 or the main direction of each printing group is parallel to the advancing direction B.

The length of the longitudinal guides 363 (and/or of the supporting walls 361 and 362) is substantially greater than the width of the support plane A, i.e. than the length of the rollers 210 of the roller conveyor 21 (but for example less than the length of the support plane A along the advancing direction B).

In practice, the support trolley 35 can slide along the sliding direction D for a (maximum) sliding stroke substantially greater than the width of the support plane A, i.e. than the length of the rollers 210 of the roller conveyor 21 (but for example less than the length of the support plane A along the advancing direction B), which is for example greater than or equal to the side of the slab L perpendicular to the advancing direction B thereof that can be decorated with the printing machine 10.

In this case, the main direction of each printing group 31 is such as to be not less than the side of the slab L parallel to the advancing direction B thereof that can be decorated with the printing machine 10.

The printing machine 10, in both of the embodiments shown, comprises a locking and centring group 40 configured to contact the slab L, locking it temporarily, i.e. holding it or stopping its motion imposed by the advancing group, and centring the same on the support plane A defined by the support 20, for example in a predetermined zero position on the support plane A.

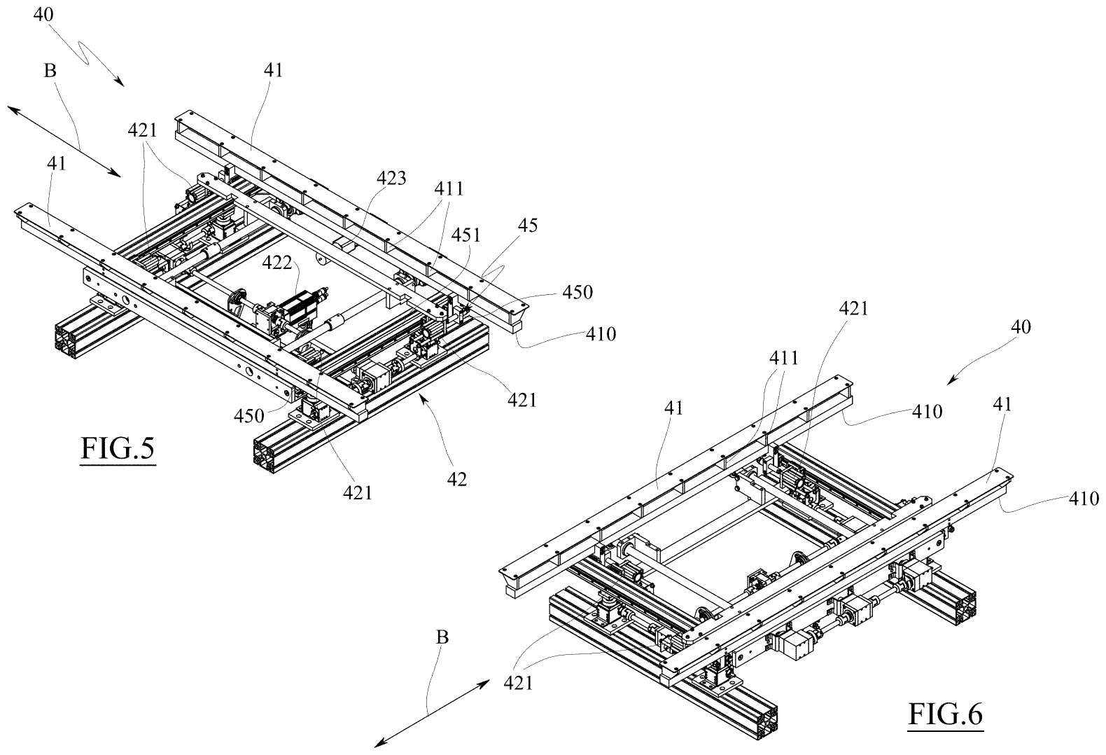

The locking and centring group 40, which is illustrated in the detail in FIGS. 4 and 5, is configured to stop the motion and temporarily block the advancing of the slab L on the support plane A (along the advancing direction B), independently from the stopping of the rotation of the rollers 210 of the roller conveyor 21 (although it can be simultaneous).

In practice, the locking and centring group 40 is configured to stop and temporarily block the slab L on the support plane A, preventing the slab L from being able to move even accidentally and imperceptibly on the support plane A, for all the time necessary for the printing groups 31 of the printing device 30 to deposit the decoration on the surface L1 of the slab L itself.

In other words, the locking and centring group 40 is configured to define a (temporary) constraint for the slab L resting on the support plane A, which is additional with respect to the constraint defined by the support plane itself.

The locking and centring group 40 is preferably, but not for limiting purposes, moveable on the support 20, i.e. at least partially above it.

The locking and centring group 40 comprises, in the illustrated example, a pair of bars 41 mutually moveable on the support 20 and configured to releasably laterally clamp the slab L arranged resting on the support plane A of the support 20.

In practice, the bars 41 are mutually moveable, suspended above the support plane A (grazing it), along a direction of movement perpendicular to the advancing direction B, which is imposed on the slab L by the rollers 210 of the roller conveyor 21.

In a (preferred) embodiment, both of the bars 41 are moveable with respect to the support plane A, towards and/or away from one another; however, this does not rule out the possibility that one of the two bars 41 can be fixed on the support plane A and the other bar 41 is moveable with respect to such a fixed bar 41. Each bar 41 is defined by an elongated (and thin) plate-like body, which has a horizontal longitudinal axis parallel to the advancing direction B of the slabs L.

Each bar 41 comprises a vertical inner wall, i.e. facing towards the other bar 41, adapted to define a (planar and vertical) contact surface with the slab L, i.e. with the opposite side walls of the slab L parallel to the advancing direction B.

The vertical inner wall can, for example, be coated with a gasket or (elastic) damping element, like for example a rubber or in any case resilient coating, to soften the mutual contact area between the bar 41 and the slab L.

The bars 41 are mutually moveable between an opened out position, wherein the distance apart (i.e. the distance between the two vertical inner walls) is the maximum and is greater than the side of the slab L perpendicular to the advancing direction B thereof that can be decorated with the printing machine 10 (for example it is not less than the main dimension of the printing groups 31) and a contracted position, wherein the distance apart (i.e. the distance between the two vertical inner walls) is the minimum and is equal to the side of the slab L perpendicular to the advancing direction B thereof that can be decorated with the printing machine 10, i.e. both of the bars 41 are in contact with the slab L resting on the support plane A.

In practice, when the bars 41 are in their opened out position they allow the advancing of the slab L on the support plane A along the advancing direction B, since they do not interfere with it, when on the other hand the bars 41 go into their contracted position (and a slab L is arranged between them) they stop the advancing of the slab L along the advancing direction B by interference, preventing any relative movement between the slab L and the support plane A.

The distance of the bars 41 from the support plane A of the slabs L is not less than the thickness of the slabs L that can be decorated with the printing machine 10.

For example, the distance of the bars 41 from the support plane A is adjustable as a function of the thickness of the slab L resting on the support plane A.

For example, the distance of the bars 41 from the support plane A is such that the bar 41 makes contact with a central area of the thickness of the slab L.

For example, the distance of the bars 41 from the support plane A is determined based on the following formula:

d=(S-s)/2;

wherein d is the distance of the bars 41 from the support plane A, S is the thickness of the slab L and s is the thickness of the bar 41, where the bar 41 has a smaller thickness than the slab L.

Thanks to such a configuration, where the slab L has chamfered (bevels), rounded or similar edges, the bars 41 can make contact with the areas of the side wall of the slab L not engaged by such processing and can in any case effectively hold the slab L.

Each bar 41 can consist of a plurality of contiguous and/or mutually spaced aligned segments or of a monolithic bar.

In the example, each bar 41 is supported above the support plane A by a support cross-member 410, which is arranged below the support plane A, i.e. below the rollers 210 of the roller conveyor 21 (a non-zero distance away from them); each support cross-member 410 can be substantially parallel to the respective bar 41 and one or more support columns 411 rise up from it, the base of said columns being rigidly fixed to the support cross-member 410 and the top of said columns being rigidly fixed to the bar 41 (for example in a dismountable manner).

Each support column 411 is slotted (with clearance) in an interspace existing between two adjacent rollers 210 of the roller conveyor 21.

The locking and centring group 40 also comprises a first actuation unit 42 configured to actuate the bars 41 in mutual motion, as described above, alternately between the opened-out position and the contracted position.

The first actuation unit comprises, for example, a first linear actuator 421, for example a pneumatic actuator, having horizontal axis.

In the example, the first actuation unit comprises at least one pair of first linear actuators 421, each of which is associated with a respective bar 41 for the (simultaneous) movement thereof.

Alternatively or additionally, for the fine adjustment of the movement between the opened out position and the contracted position or the centring thereof as a function of the width of the slab L (in the direction perpendicular to the advancing direction B thereof), it is possible to provide for the first actuation unit 42 to be able to comprise a first motor, for example a first rotary motor 423, adapted for horizontally moving a respective bar 41 or, like in the preferred embodiment, (both of) the bars 41.

Moreover, the first actuation unit 42 can be configured to carry out the adjustment of the distance of the bars 41 from the support plane A.

For this purpose, the first actuation unit 42 can also comprise a second motor, for example a second rotary motor 422, adapted for vertically moving a respective bar 41 or, like in the preferred embodiment, (both of) the bars 41.

The locking and centring group 40 can also comprise a front rail 43, which is adapted for being arranged on the support plane A in front of the slab L in the advancing direction thereof (imposed by the rotation of the rollers 210 of the roller conveyor 21) along the advancing direction B (from an inlet to an outlet), so as to contact the front end of the slab L and prevent the advancing of the slab L along the advancing direction B itself.

The front rail 43 is adapted to make contact with a front side wall (in the advancing direction thereof imposed by the rotation of the rollers 210 of the roller conveyor 21 along the advancing direction B) of the slab L resting on the support plane A to stop the slab L on the support plane A.

The front rail 43 is moveable with respect to the support 20, i.e. with respect to the support plane A thereof, between a position of non-interference with the slab L, in which it is arranged in a position in which it allows the slab L advancing along the advancing direction to pass, and a position of interference with the slab L, in which it is adapted to make contact with the slab L to stop the movement thereof on the support plane A.

In particular, the front rail 43 is slidably moveable along a direction perpendicular to the support plane A, i.e. vertically, alternately between the aforementioned positions of non-interference and position of interference.

In the illustrated example, in the position of interference the front rail 43 is arranged above the support plane A, for example a distance from it not greater than the thickness of the slabs L that can be decorated with the printing machine 10.

In the position of non-interference, the front rail 43 can be arranged (totally) below the support plane A, for example retractably inside an interspace existing between two adjacent rollers 210 of the roller conveyor 21.

The front rail 43 is defined by an elongated (and thin) plate-like body, which has a horizontal longitudinal axis perpendicular to the advancing direction B of the slabs L.

The front rail 43 comprises a vertical rear wall, i.e. facing towards the slab L that enters the support plane A in the advancing direction along the advancing direction B, adapted for defining a (flat) contact surface with the slab L, i.e. with the front side wall thereof perpendicular to the advancing direction B, (vertical and) perpendicular to the advancing direction B.

In the illustrated example, the front rail 43 and the bars 41 intersect, for example close to a downstream end of the bars 41 (in the advancing direction of the slabs in the advancing direction B), however this does not exclude the possibility that the front rail 43 is arranged at the downstream end of the bars 41 or distal and axially separate from it.

The vertical rear wall can, for example, be coated with a gasket or (elastic) damping element, like a rubber or in any case resilient coating, to soften the mutual contact area between the front rail 43 and the slab L.

The locking and centring group 40 also comprises a second actuation unit configured to actuate the front rail 43 in motion with respect to the support plane A, as described above, alternately between the position of non-interference and the position of interference.

The second actuation unit comprises, for example, a second linear actuator 44, for example a pneumatic actuator, having vertical axis.

According to an advantageous aspect of the invention, the printing machine 10 comprises a measuring group 45, which is configured to measure at least one parameter indicative of a dimension, for example a width and/or a length, of the slab L arranged on the support plane A, i.e. arranged on the rollers 210 of the roller conveyor 21 of the printing machine 10.

In particular, the measuring group 45 is configured to measure the width (dimension parallel to the rotation axis of the rollers 210 or horizontal and perpendicular to the advancing direction B) and/or the exact length (dimension perpendicular to the rotation axis of the rollers 210 or horizontal and parallel to the advancing direction B) of the slab L.

The measuring group 45 comprises at least one sensor element configured to detect and determine the position of two opposite (parallel) vertical walls of the slab L, for example with respect to a reference system (x,y) on the support plane A or relative between them.

The measuring group 45 is defined integral or on-board the locking and centring group 40.

In practice, the measuring group 45 is configured to determine the (mutual) position of two opposite (parallel) vertical walls of the slab L, i.e. the width and/or the length of the slab L, as an indirect measurement between two or more elements of the locking and centring group 40.

For example, in order to detect the width of the slab L, the sensor element is configured to detect and measure the distance between the bars 41 when they are in their contracted position, i.e. they clamp the slab L.

As stated, when the bars 41 are indeed in their contracted position with the slab L arranged between them, the distance between the bars 41 is the minimum and corresponds to the dimension of the width of the slab L, i.e. the dimension of the side of the slab L perpendicular to the advancing direction B.

For such purposes, the sensor element could provide for a position transducer 450 (as visible in FIG. 5), for example a magnetic band position transducer, which is fixed to one of the bars 41, for example it is fixedly connected with it in the sliding carried out by the bar 41 between the opened-out position and the contracted position.

Preferably, each bar 41 carries (or is connected to) a respective position transducer 450.

The position transducer 450 is configured to determine an (absolute) position of the respective bar 41 (i.e. of the respective vertical inner wall).

Each position transducer 450 is for example fixed below the support plane A, for example it is rigidly fixed (below) the support cross-member 410 of the respective bar 41.

For example, the sensor element also comprises a magnetic band 451, for example longitudinal and having a longitudinal axis parallel to the rotation axis of the rollers 210, i.e. horizontal and perpendicular to the advancing direction B), which is fixed (i.e. stationary) with respect to the support plane A, for example fixed below it (under the rollers 210) on a beam fixed to the frame 212 of the roller conveyor 21.

Each position transducer 450 (singularly) is configured to determine a position of the bar 41 as a function of a change of position thereof with respect to (and along) the magnetic band 451.

Alternatively to what has been described above it is possible to provide for other measuring means, like for example optical groups or position transducers connected to the motors of the bars 41, like encoders or similar.

Moreover, in order to detect the length of the slab L, the sensor element can be configured to detect and measure the distance between the front rail 43 (when the vertical face thereof is in contact with the front side wall of the slab L) and the (free) rear side wall of the slab itself.

For these purposes, the sensor element could provide for a rear optical group that is not illustrated (for example comprising a series of photocells or a television camera or other), which is for example fixed to the frame 212.

The rear optical group is configured to measure or determine the position along the advancing direction B of the (free) rear side wall of the slab L with respect to the (axially fixed) position of the front rail 43 (i.e. the vertical face thereof in contact with the front side wall of the slab L) and, therefore, determine the length of the slab L as a function of said measured or determined position.

The printing machine 10 also comprises a protective casing 50 (visible only in FIG. 1), which is closed to contain the support 20, the printing device 30 and the locking and centring group 40 and is openable, with suitable hatches, to inspect the content thereof.

Moreover, the protective casing 50 is equipped with at least one optically transparent window for the inspection and checking of the content and of the printing process carried out by the printing machine 10.

For example, the protective casing 50 encloses an (inner) environment of the printing machine 10, which can preferably be a controlled environment, for example climate-controlled, wherein the parameters of the air arranged inside are monitored and controlled.

In particular, the printing machine 10 comprises means adapted for controlling the climate inside the protective casing 50 and a control group adapted for monitoring and checking the parameters of the air inside the protective casing 50 to optimise the printing operations.

The printing machine 10 also comprises an electronic control unit U (illustrated only schematically in FIG. 1), which is configured to manage the work steps of the printing machine 10 in an automated manner.

The electronic control unit U, for example, is operatively connected to the motor 211 of the roller conveyor 21 and/or to the injectors of each printing group 31 and/or to the linear motor 37 and/or to the first actuation unit 42 (i.e. to the first linear actuator 421, to the first rotary motor 423 and/or to the second rotary motor 422) and/or to the second linear actuator 44 for the management and control of the automated operation of the printing machine 10.

The electronic control unit U can also be operatively connected to the measuring group 45.

In this case, the electronic control unit U can be configured to determine or measure at least one (real) dimension of the slab L (arranged in the printing machine 10) and determine or change the decoration to be printed with each printing group 31 (i.e. change the actuation of each printing group 31) as a function of the dimension determined or measured, in order to optimise the deposition of the printing ink (only) on the surface L1 of the slab L without going outside it.

With particular reference to FIG. 1, the plant, in addition to what has been described above, could also include a preheating device 60 configured to preheat (up to a predetermined temperature) the surface L1 of the slabs L before they are introduced in the printing machine 10.

For example, the preheating device 60 is arranged upstream of the printing machine 10 in the advancing direction of the slabs L along the advancing direction B imposed by the roller conveyor 21 of the printing machine 10.

The preheating device 60 (per se known by those skilled in the art) is, for example, equipped with a suitable inlet roller conveyor coplanar to the roller conveyor 21 of the printing machine 10.

Furthermore, in addition to what is described above, the plant could also include a drying device 70 configured to heat (up to a predetermined temperature) the surface L1 of the slabs L and dry the decorative fluid after it has been deposited by the printing machine 10.

For example, the drying device 70 is arranged downstream of the printing machine 10 in the advancing direction of the slabs L along the advancing direction B imposed by the roller conveyor 21 of the printing machine 10.

The drying device 70 (per se known by those skilled in the art) is, for example, equipped with a suitable outlet roller conveyor coplanar to the roller conveyor 21 of the printing machine 10.

In light of what is described above, the control method (automatically managed and controlled by the electronic control unit U) of the printing machine 10 is as follows.

A slab L or a sequence of slabs L to be decorated is made to advance on a transportation line with its surface L1 to be decorated facing upwards (see FIG. 1).

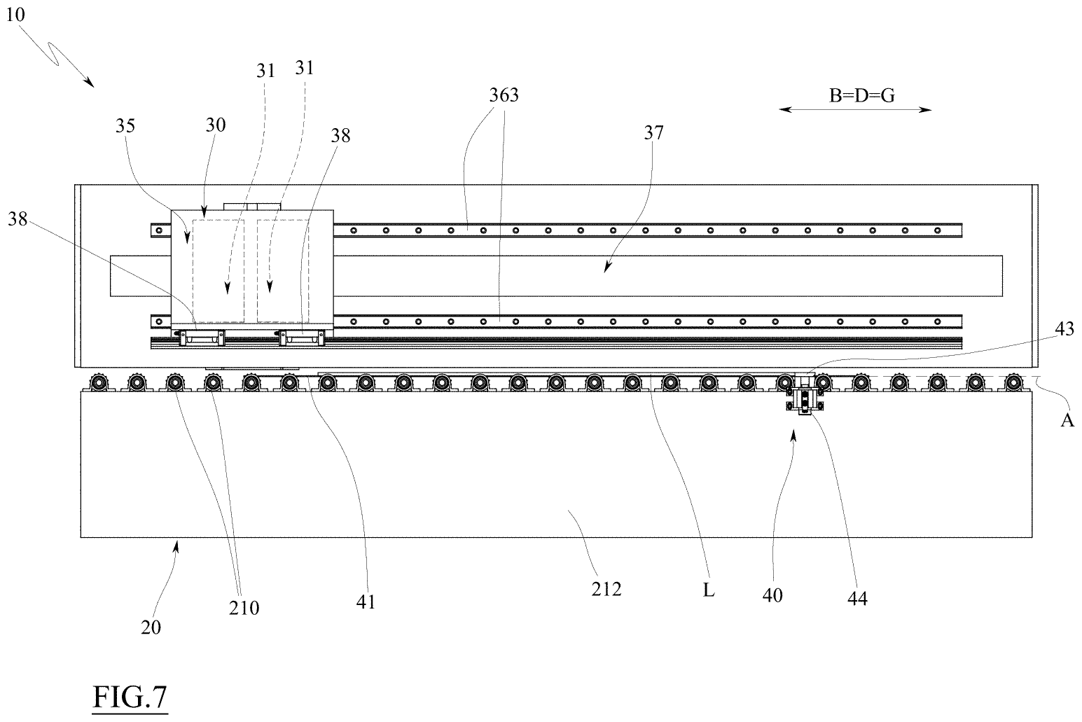

Each slab L (singularly), thus arranged and possibly preheated, enters the printing machine 10 (see FIGS. 7-8 and 11-12), i.e. it is received by the support plane A, for example defined by the rollers 210 of the roller conveyor 21, and made to advance by it along the advancing direction B.

Preferably, when the slab L enters the printing machine 10 the front rail 43 is taken into its position of interference (and the bars 41 are in their opened-out position).

In this way, when the slab L reaches the front rail 43 it stops the advancing of the slab L, which will be stopped in a predetermined axial zero position thereof along the advancing direction B (see FIGS. 7-8 and 11-12).

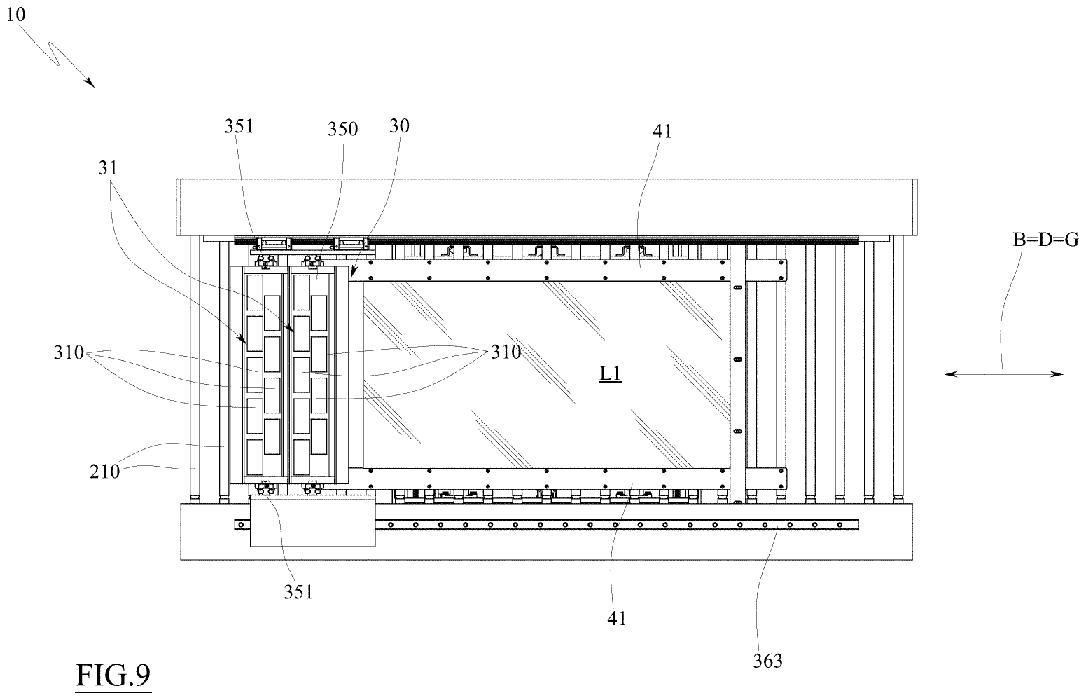

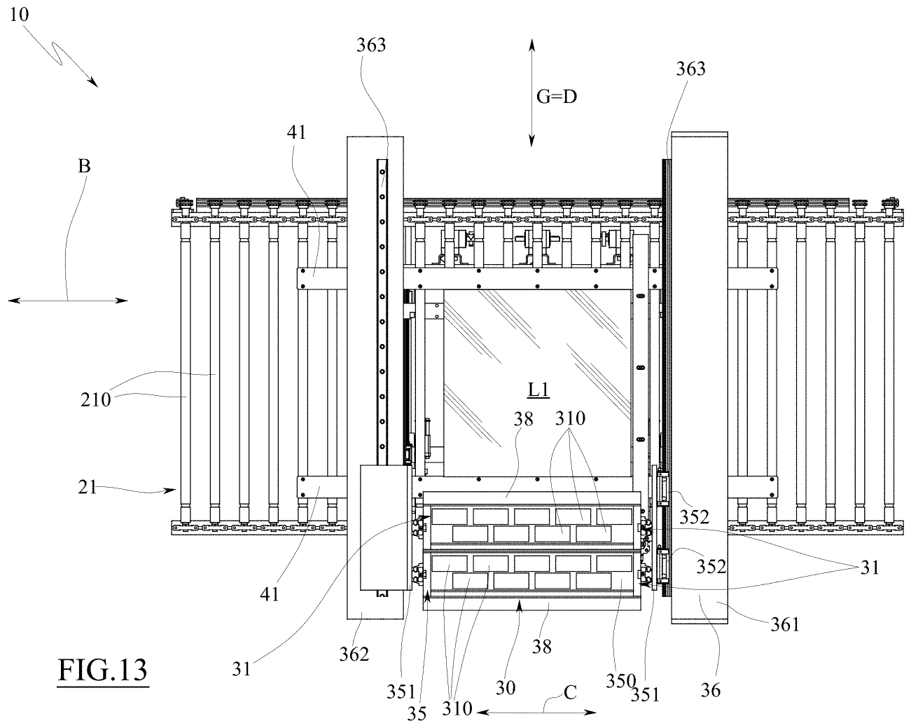

At this point the bars 41, the position of non-interference of which had been previously calibrated with the second rotary motor 422 and the distance of which from the support plane A had been previously adjusted through the first rotary motor 423), can thus be actuated (through the first linear actuator 421) from the opened out position to be taken into their contracted position (see FIGS. 9 and 13), in this way the slab L is firmly held and locked (stopped) with respect to the support plane A.

Moreover, the bars 41 in the contracted position are such as to lock the slab L in a predetermined transversal zero position thereof along the direction perpendicular to the advancing direction B, which preferably but not for limiting purposes corresponds to the position in which the slab L has a vertical median plane substantially coinciding with the vertical median plane of the rollers 210 of the roller conveyor 21.

At the same time or after the actuation of the bars 41 the rotation of the rollers 210 of the roller conveyor 21 can be stopped, stopping the motor 211.

With the slab L thus firmly stopped and centred on the support plane A, the printing machine 10 is configured to be able to actuate the printing device 30, so as to decorate—according to a predetermined decoration—the surface L1 of the slab L.

In particular, the printing device 30 is actuated, through the linear motor 37, so that the support trolley 35 slides along the sliding direction D, for example with the possibility to be actuated in both sliding directions, i.e. in a forward sliding direction and in an opposite backwards sliding direction.

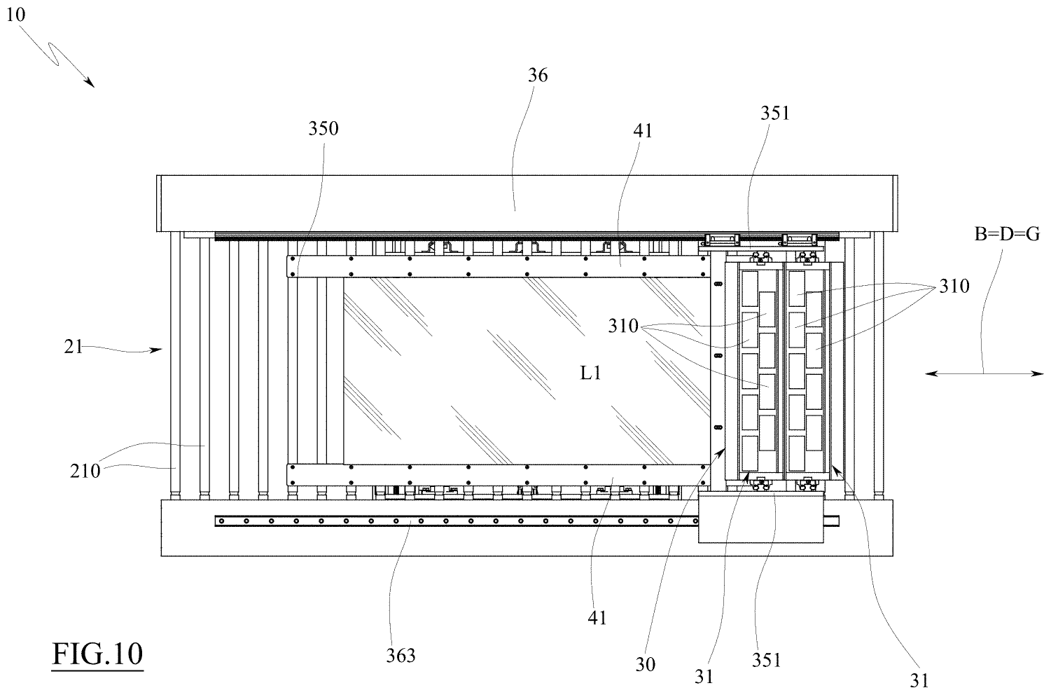

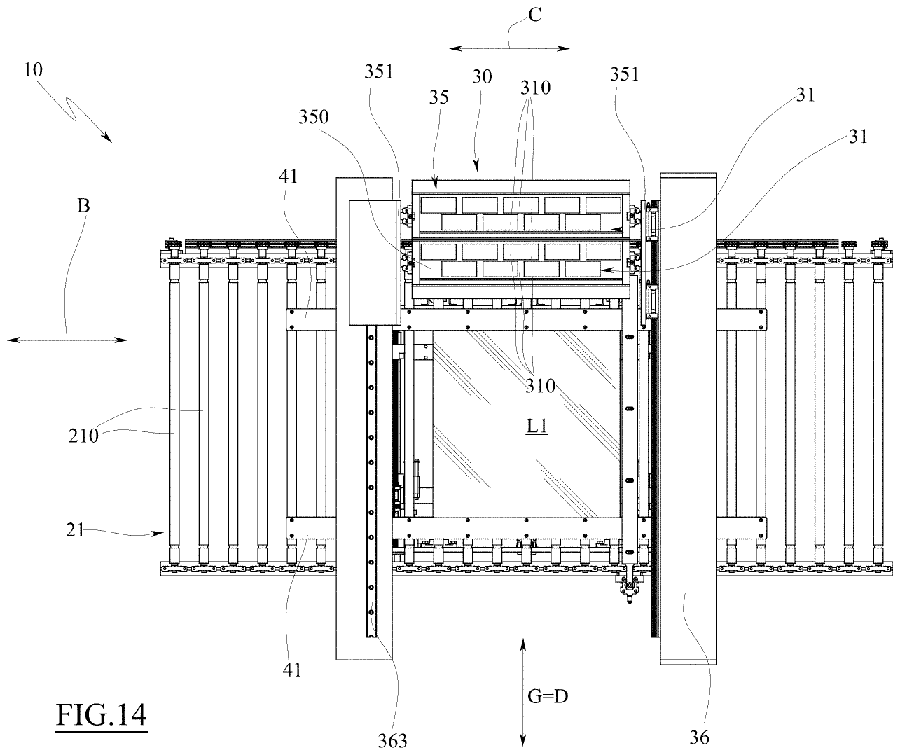

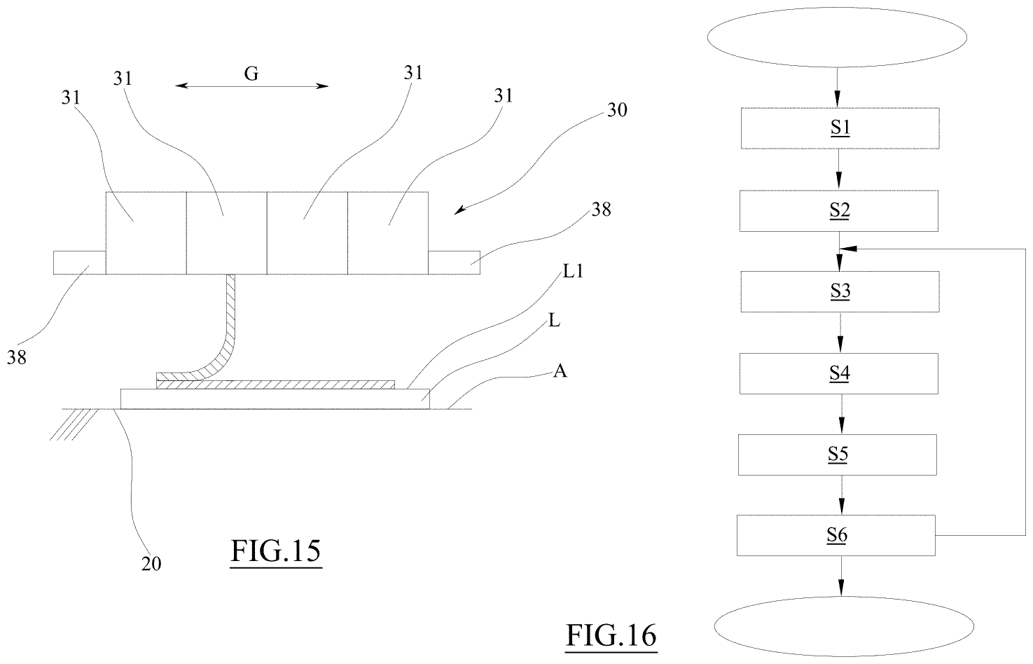

The support trolley 35 is shown in an end stop position in FIGS. 10 and 14. With the support trolley 35, therefore, each printing group 31 fixed to it slides along such a sliding direction D releasing on the surface L1 of the slab L a predetermined decoration, preferably a predetermined layered decoration.

In particular, the electronic control unit U is configured to determine (block S1) a layered decoration to be made with the printing device 30, i.e. with the printing groups 31 thereof, on the surface L1 of each slab L, wherein the layered decoration is formed from the juxtaposition of a plurality of layers of monochromatic decoration, each of which is obtained respectively from a single printing group 31 (or a plurality of printing groups 31 loaded with the same colour).

In practice, the layered decoration determined is defined by the juxtaposition of a plurality of monochromatic decorative motifs (the same or different from one another), for example in the form of predetermined rendered (two-dimensional) images, for example stored in a memory unit of the electronic control unit U.

The electronic control unit U is also configured to set (block S2) an activation sequence of one or more printing groups 31 during the sliding of the printing device 30 along the sliding direction D as a function of the determined layered decoration, i.e. adapted to reproduce the same chromatic scheme of the layered decoration determined previously.

In particular, the electronic control unit U is configured to determine which of the printing groups 31 is intended to make a respective monochromatic layer.

Moreover, the electronic control unit U is configured to assign to each printing group 31 a determined activation order based on the layered decoration determined, i.e. on the (vertical) position of the respective monochromatic layer in the predetermined layered decoration.

In particular, the activation sequence is a sequence of n components, in which n is the number of monochromatic layers of which the layered decoration is composed.

For example, if the layered decoration determined is formed from three monochromatic layers—a first white lower layer, a second red intermediate layer and a third black upper layer—then the activation sequence will provide for assigning the printing group 31 containing the colour white the first order of activation, the printing group 31 containing the colour red the second order of activation and the printing group 31 containing the colour black the third order of activation, independently from the mutual position along the direction of mutually adjacent arrangement G with which such printing groups 31 are arranged in the printing machine 10.

At this point, the electronic control unit U is configured to actuate (block S3) the sliding of the printing device 30 along the sliding direction D, in a sliding direction, for example in the forwards sliding direction, on the slab L resting on the support 20.

In practice, the electronic control unit U actuates, through the linear motor 37, the support trolley 35 so that the printing groups 31 mounted on them slide along the sliding direction D, whereas the slab L remains stationary on the support 20.

At the same time, the electronic control unit U is configured to activate (block S4) one or more printing groups 31 during the sliding of the printing device 30 along the sliding direction D (when the printing groups 31 are vertically aligned with the slab L) based on the set activation sequence and on a predetermined mutual position of the printing groups 31 along the direction of mutually adjacent arrangement G and/or on the relative motion between support 20 and printing device 30. In practice, each printing group 31 is activated to make its own monochromatic layer, made up of the respective monochromatic decorative motif on the slab L, in a given mutual position with respect to the others and to the slab L.

In practice, in the example given above, if the mutual position of the printing groups 31 is such that the printing group 31 containing the colour white is in front of the printing group 31 containing the colour red, which in turn is in front of the printing group 31 containing the colour black, in the forwards sliding direction of the printing device 30 on the support 20, then it is possible that with a single outward stroke (or pass) in the forwards sliding direction the printing device 30 deposits the entire layered decoration (and decorates the entire surface L1 of the slab L or in any case the entire area thereof that houses the entire decoration that constitutes the decoration of the slab L).

Alternatively, if the mutual arrangement of the printing groups 31 is not that described above (i.e. for the mutual arrangement—for example fixed—of the printing groups 31 in the machine, it is not such as to be able to deposit a predetermined sequence of layers of monochromatic decoration in a single outward or return stroke), it is possible for the complete layered decoration to be deposited (block S4) on the (same) slab L with a plurality of outward and/or return strokes (or passes), in the forwards sliding direction and in the opposite backwards sliding direction, of the group of printing heads 310 (with order of the colour able to be selected, for example by the user, on each occasion).

Since the slab L is completely stopped by the locking and centring group 40 on the support plane A defined by the roller conveyor 21, the printing device 30 extremely precisely deposits the drops of decorative fluid in the position predetermined by the pattern of layered decoration (also in multiple passes).

From the above it is clear that the printing device 30 is capable of making any juxtaposition of monochromatic layers (in any sequence) on the same slab L, for example repeating in the same layered decoration a plurality of monochromatic layers of the same colour or in sequences repeated in different or the same sub-sequences, with a single printing group 31 for each colour (independently from the mutual arrangement of the printing groups 31 in the machine, i.e. also on each occasion leaving the positions of such printing groups 31 in the machine fixed or changing them as desired/randomly).

In the case in which the printing machine 10 comprises a single printing group 31 (or all of the printing groups 31 are loaded with the same colour) it is clear that the electronic control unit U can be configured to carry out a (monochromatic) layered decoration according to the methods described above, i.e. to carry out a complete/whole layered decoration with a single outward stroke (or pass) in the forwards sliding direction the printing device 30 with a plurality of outward and/or return strokes (or passes), in the forwards sliding direction and in the opposite backwards sliding direction, of the group of printing heads 310 (with order of activation of the printing groups 31, where more than one were selectable, for example by the user, on each occasion).

The electronic control unit U can also be configured to change (block S5) the determining of the layered decoration to be reproduced on one or more successive slabs L of the succession of slabs L that enter the printing machine 10 and, thus, to correspondingly change (block S6) the setting of the activation sequence between two successive slabs L of the sequence of slabs L.

Once the above has been changed, the electronic control unit U is configured to repeat what is described above in block S3 and in block S4 on the next slab L so as to make a different layered decoration (at least for the invention of the monochromatic layers of which it is composed) on one or more successive slabs L. From the above it is clear that the printing device 30 is capable of making any juxtaposition of monochromatic layers on different slabs L (in any sequence), for example changing the layered decoration obtained between one slab and the next one with the same configuration (and mutual arrangement in the machine) of printing groups 31.

In order to facilitate the deposition of the decoration, it is possible to actuate the heating device 38, or both of the heating devices 38, so as to effectively preheat the surface L1 before the deposition of the decorative fluid and/or dry the decorative fluid as soon as it has been deposited on the preheated surface L1.

Once the deposition of the decoration on the surface L1 of the slab L has ended, i.e. at the end of one or more passes of the printing groups 31 on the surface L1, it is sufficient for the bars 41 to be brought back into their opened out position and the front rail 43 into its position of non-interference and, by setting in rotation the rollers 210 of the roller conveyor 21 it is possible to advance the slab L, thus freed and decorated, towards the next processing station of the plant.

The invention thus conceived can undergo numerous modifications and variants all of which are encompassed by the inventive concept.

Moreover, it is possible to provide for obtaining protection over aspects linked to the printing machine 10 independently from the locking and centring group 40 described above, and for example able to be used as single-pass or in other operative modes.

Moreover, all of the details can be replaced by other technically equivalent elements.

In practice, the materials used, as well as the contingent shapes and sizes, can be whatever according to the requirements without for this reason departing from the scope of protection of the following claims.

REFERENCE NUMERALS

| slab | L |
|---|---|
| surface | L1 |
| printing machine | 10 |
| support | 20 |
| support plane | A |
| advancing direction | B |
| roller conveyor | 21 |
| rollers | 210 |
| motor | 211 |
| frame | 212 |
| printing device | 30 |
| printing group | 31 |
| direction of mutually adjacent arrangement | G |
| printing heads | 310 |
| direction of adjacent arrangement | C |
| support trolley | 35 |
| lower wall | 350 |
| flanks | 351 |
| slides | 352 |
| sliding direction | D |
| supporting structure | 36 |
| vertical supporting wall | 361 |
| horizontal supporting wall | 362 |
| longitudinal guides | 363 |
| linear motor | 37 |
| heating device | 38 |
| locking and centring group | 40 |
| bars | 41 |
| support cross-member | 410 |
| support columns | 411 |
| first actuation unit | 42 |
| first linear actuator | 421 |
| first rotary motor | 423 |
| second rotary motor | 422 |
| front rail | 43 |
| second linear actuator | 44 |
| protective casing | 50 |
| electronic control unit | U |
| preheating device | 60 |
| drying device | 70 |

1. A method for controlling an inkjet printing machine on slabs, wherein the printing machine comprising:
a support for supporting a slab; and
a printing device that is movable above the support along a sliding direction and spaced apart from it, wherein the printing device is provided with a plurality of printing groups arranged adjacent with respect to a direction of mutually adjacent arrangement parallel to the sliding direction and each printing group is equipped with at least one inkjet printing head, wherein each printing group is configured to release a respective monochromatic decoration on a surface of the slab resting on the support, and
wherein the method comprises:
determining a layered decoration to be made with the printing device on the surface of the slab, wherein the layered decoration is formed from the juxtaposition of a plurality of layers of monochromatic decoration;
setting an activation sequence of one or more printing groups during the sliding of the printing device along the sliding direction as a function of the determined layered decoration;
making the printing device slide along the sliding direction on the slab resting on the support;
activating one or more printing groups during the sliding of the printing device along the sliding direction based on the set activation sequence and on a predetermined mutual position of the printing groups along the direction of mutually adjacent arrangement.

2. The method according to claim 1, wherein the printing machine is configured to decorate the surface of a plurality of slabs in sequence, the method further comprising:
changing the determining of the layered decoration and the setting of the activation sequence between two successive slabs of the sequence of slabs.

3. The method according to claim 1, wherein the printing device is movable above the support along the sliding direction in both a forward sliding direction and a backwards sliding direction, the method further comprising:
depositing, through the printing groups, the complete layered decoration on the same surface of the same slab with a plurality of outward and/or return strokes, respectively in the forwards sliding direction and/or in the opposite backwards sliding direction.

4. The method according to claim 1, wherein the printing machine comprises a locking and centering group configured to contact the slab temporarily locking and centering the slab on the support, the method comprising:
actuating the locking and centering group during the movement of the printing device along the sliding direction.

5. The method according to claim 1, wherein the support comprises a horizontal support plane that comprises an advancing group for advancing the supported slab along a predetermined horizontal advancing direction, the method comprising:
making the printing device slide along the sliding direction on the slab resting on the support, wherein the sliding direction of the printing device is horizontal and parallel or perpendicular to the advancing direction.

6. An inkjet printing machine on slabs, wherein the printing machine comprising:
a support for supporting a slab; and
a printing device that is moveable above the support along a sliding direction and spaced apart from it, wherein the printing device is provided with a plurality of printing groups arranged adjacent with respect to a direction of mutually adjacent arrangement parallel to the sliding direction and each printing group is equipped with at least one inkjet printing head, wherein each printing group is configured to release a respective monochromatic decoration on a surface of the slab resting on the support.

7. The printing machine according to the previous claim, which comprises an electronic control unit configured to actuate the method according to claim 1.

8. The printing machine according to claim 6, which further comprises:
a locking and centering group configured to contact the slab temporarily locking and centering the slab on the support.
